(19) United States
(12) Patent Application Publication
(10) Pub. No.: US 2003/0149940 A1
(43) Pub. Date: Aug. 7, 2003

(54) Document assembly from a database

(76) Inventors: Paul Mervyn Fordyce, Burraneer (AU); Don McCamey, Terry Hills (AU)

Correspondence Address: LARSON & TAYLOR, PLC, 1199 NORTH FAIRFAX STREET, SUITE 900, ALEXANDRIA, VA, 22314, US

(21) Appl. No.: 10/204,601

(22) PCT Filed: Feb. 23, 2001
(86) PCT No.: PCT/AU01/00195

(30) Foreign Application Priority Data
Feb. 25, 2000 (AU) PQ 9152

(51) Int. Cl. G06F 15/00

(52) U.S. Cl. 715/530

(57) ABSTRACT

The present invention provides a method of assembling a document from a plurality of passages of information stored in a respective plurality of records on a database, each record including at least one descriptor which is indicative of a characteristic of information contained in the passage of the respective record, comprising: selecting at least two records from the plurality of records, the selected records comprising all records having a descriptor which matches a descriptor chosen by a user, creating a document containing the passages of the selected records; presenting the document such that the passages contained in it are directly viewable by a user. The present invention also provides a system for implementing the method.

### TECHNICAL FIELD

The present invention concerns a method of assembling a document from information contained in a database. A further aspect of the invention concerns a system for implementing the method.

### BACKGROUND OF THE INVENTION

Computer databases have become a common way of accessing information which, prior to the age of computers, would have been printed on paper. Databases now commonly store encyclopaedias, phone books, instruction manuals, and so on, and have the advantage that they can be searched using a variety of different database searching algorithms. For example, an encyclopaedia stored on a database can be searched using predetermined selection criteria, such as subject, keyword, or date. In particular, a legal resource database may be searched for information about a particular topic of law.

Text information is commonly divided into a plurality of separate paragraphs or passages, each of which is stored as a separate data structure sometimes referred to as a “record”. Each record can be searched and retrieved separately from a database. One disadvantage with such prior art databases is that a search can provide a large group of separate records which a user then needs to access individually in order to obtain the stored information. For example, a search for a name “X” might reveal a vast number of records which a user will need to separately retrieve.

A further disadvantage with prior art databases is that a user needs to be familiar with the terminology used in the database in order to enter the appropriate search query. For example, a database may discuss a particular topic using technical terms unfamiliar to the user. If the user searches for information about the topic using non-technical keywords, the database may erroneously indicate that there is no relevant information available, even if the non-technical keywords are equivalent to the technical terms.

Furthermore, conventional systems extract all the available information from a database related to the search query entered. The information is not tailored according to the background or needs of a user because advanced and introductory information is presented together. For example, a lay person may find it unhelpful to be provided with technical information aimed at professionals, but will need to filter through such information to seek introductory information. Conversely, a professional in a particular field may not wish to read information aimed at amateurs, but may be forced to skim past such information where the information has been located by a particular search. The prior art does not provide any way of overcoming these problems.

### SUMMARY OF THE INVENTION

The present invention provides a method of assembling a document from a plurality of passages of information stored in a respective plurality of records on a database, each record including at least one descriptor which is indicative of a characteristic of information contained in the passage of the respective record, comprising:

selecting at least two records from the plurality of records, the selected records comprising all records having a descriptor which matches a descriptor chosen by a user;

creating a document containing the passages of the selected records;

presenting the document such that the passages contained in it are directly viewable by a user.

The term “document” is understood to include information displayed electronically as well as information printed as a hard copy. When the document is presented electronically, such as on a computer screen, it is understood that the contents of the document (i.e. the passages) are all immediately visible to a user or can be progressively scrolled through bit-by-bit, without changing levels in a directory structure. Thus, the document information to be viewed by the user is not partially contained in files or folders within the document. Also, the term “document” does not include within its scope a virtual “desktop” on a computer operating system where directories and sub-directories are represented. Further, the term “document” does not encompass a web page containing a summary of search results provided by a search engine, as the information within each search result cannot be viewed by the user without opening a folder or linking to a different website. The present invention is therefore different to prior art systems such as that disclosed in U.S. Pat. No. 5,924,090 (Krellenstein) where search results are divided into a range of categories based on characteristics of the data. Each category in the system of Krellenstein is displayed as separate folder which needs to be opened separately in order to view the contents. Thus, Krellenstein does not assemble a document in which passages contained in it are directly viewable by a user.

The plurality of records and the information contained therein are preferably stored digitally on the database. The method may be implemented on a digital computing device.

Each passage presented in the document may be in the form of, but is not limited to, one or more of the following: a text character; a text word; a text phrase; a text paragraph; a symbol; a number; a data sequence; an image; and a drawing. The information in each passage may comprise almost any type of information capable of being stored on a database. Examples of possible passage arrangements include one or more of the following: a heading; a sub-heading; a body of text; a footnote; or a hyperlink. Examples of characteristics indicated by a descriptor include, but are not limited to:

type of information contained in a passage, e.g. “case law quote”, “commentary”, “statute”;

level of complexity of information contained in a passage, e.g. “introductory”, “advanced”;

quantity of information contained in a passage;

quality of information contained in a passage, e.g. “reliable source”, “comprehensive coverage”;

source of information contained in a passage, e.g. “refereed journal article”, “book chapter”; or

language of information contained in a passage.

The document preferably comprises a collation of passages arranged such that an article is created. The passages may be arranged sequentially. The document may be presented to the user in electronic form, such as on a computer screen, or may be presented in the form of a hard copy, such as a paper print.

In one embodiment, each passage is a single paragraph of text containing a commentary on a separate aspect of patent law. The method allows a new document to be created in which selected passages are assembled in the form of a commentary article which sequentially discusses various aspects of patent law. An advantage of such an embodiment is that the assembled document is much easier for a user to digest that a multitude of isolated records. In addition, the contents of the document can be automatically changed to meet the needs of the user by selecting passages with the appropriate characteristics. The modular nature of each passage provides flexibility which enables different types of documents to be assembled, depending on user requirements.

The method may further comprise selecting all records which, in addition to having a descriptor which matches a user-chosen descriptor, also satisfy a second selection criterion. The second selection criterion may be based on the information contained in each passage. Examples of criteria which may constitute the second selection criterion include the occurrence of user-entered terms such as characters, words, names, titles, phrases, dates, contexts, subjects, or combinations of two or more of these. For example, in the case of a database containing legal resources such as case law, statutes and commentaries, the selection criterion may comprise a search for one or more of the following:

topic;

statute reference;

case name;

case reference;

judge name;

quote; or

keyword.

The selection of records based on the second selection criterion may comprise:

receiving a user-entered first search term; and

providing the user with a suggested alternative search term related to both the first search term and at least one of the plurality of records in the database.

The alternative search term may be another term having a meaning which is the same or similar to the meaning of the first search term, or it may be a term concerning a topic which is similar or closely-related to a topic of the first search term. The alternative search term may also concern a sub-topic of the first search term. Preferably, the user is given the option of either continuing the selection using the first search term, or substituting the first search term with an alternative search term. The user may be provided with a plurality of alternative search terms and given the option of entering one of the alternative search terms instead of the first search term. The user may also enter a combination of a plurality of alternative search terms, or a combination of the first search term and one or more alternative search terms. The step of providing alternative search terms helps make the selection process more user-friendly. Prior art searching tools do not guide the selection process in this way. The user of prior art tools needs to be able to anticipate the terms used in the database in order to access the required database information. A result will not be achieved if the database uses a term which is different to the search term but has an equivalent meaning. For example, the following terms mean generally have the same meaning in legal terminology;

equitable charge;

mortgage;

mortgaged debenture;

fixed and floating charge;

fixed charge; and

floating charge.

There are then a multitude of terms that apply to what happens when the charge is registered, enforced, etc and other scenarios relative to what a person may want to know about a charge. It is conceivable that a user of prior art databases will not be able to find anything at all on the topic of choice due to the choice of search term. Alternatively, the search may reveal far too much information to be of any use because the search term may have many different connotations.

The step of providing alternative search terms may be implemented by preparing an index which guides a user from a term that the user might consider to be the right term, to one that may be used in the records.

Without the descriptor-based selection, the search may select a significant number of records. Some of the records may be highly technical and therefore not relevant to lay people, while other records in the first set may be introductory and not relevant to professionals in the field.

The user may choose more than one descriptor. Preferably, the method allows a user to choose a set of descriptors. An interim text document can be formed from the passages selected in accordance with the second selection criterion, and the user-chosen set of descriptors can be used to cull unnecessary information from the interim document by only displaying passages with one or more characteristics chosen by the user For example, the method can enable a user to discard passages characterised by the descriptors as being advanced or simple, thus leaving intermediate-level passages.

In one embodiment, the database comprises a legal resources database in which there are three types of descriptors, namely A, B, and C, which indicate the level of complexity of information in each record as follows:

A, advanced material, including highly technical material such as a judge name, a case name, or a quote;

B, intermediate material, such as reproductions of passages from relevant statutory material and intermediate level commentaries;

C, introductory material, such as elementary coverage of an area of law suitable for providing an introduction to a field of law for a lay reader or a professional advisor unfamiliar with the area of law.

A record may include a plurality of descriptors since some records may be suitable for more than one type of user. For example, a record in the above embodiment might include descriptors B and C because it may be suitable for lay readers as well as intermediate-level users.

The user-chosen set of descriptors may comprise a combination of two or more descriptors. For example, the user-chosen set of descriptors may comprise any one of the following: A; B; C; AB; BC; AC; or ABC. By selecting a combination of descriptors, the user may read information with more than one characteristic. For example, this feature provides the option of viewing advanced material combined with intermediate material, while omitting introductory material, thereby giving a user further control over the selection of information. In other words, the descriptors can be used to filter out particular types of information.

Alternatively, a descriptor may be linked to at least one other descriptor such that a user effectively chooses all of the linked descriptors by choosing one of the descriptors. For example, the three descriptors A, B and C may be linked together such that when a user chooses A, all of the descriptors A, B and C are added to the user-chosen set of descriptors. In other words, when a user chooses the descriptor for highly technical material, the method assembles a document in which the highly technical material is accompanied by the intermediate and introductory material.

Each record may also include at least one attribute definer to define a function or format of the passage contained in the record. An attribute definer may ensure that the information in each record is positioned correctly in the document (eg. a heading must be positioned at the beginning of a body of text), or is given the correct text format (eg. a particular font appropriate for the function of the text). An important difference between a descriptor and an attribute definer is that a descriptor can be used to choose a record, while an attribute definer defines the attributes of a chosen record. A user cannot choose the attributes of a record.

The method may also be used to access information at progressively more complex levels of detail. For example, a user may initially limit the information to introductory material, but can seek progressively more advanced information if required by changing the user-chosen set of descriptors.

It will be understood that many different types of descriptors can be defined depending on the type of information contained in each record.

A second aspect of the invention provides a system for assembling a document from a plurality of passages of information stored in a respective plurality of records on a database, each record including at least one descriptor which is indicative of a characteristic of information contained in the passage of the respective record, the system comprising:

a selection means for selecting at least two records from the plurality of records such that each of the at least two records satisfies both of the following conditions: each selected record includes a descriptor which matches a descriptor chosen by a user; each selected record satisfies a second selection criterion;

a document assembly means for assembling the passages of the selected records into a document;

a medium for presenting the document such that the passages contained in it are directly viewable by the user.

Each record and descriptor may be in accordance with any one of the records and descriptors described above. The selection means may comprise a digital searching tool operating on a computing device. The document assembly means may comprise a digital computing device. The medium for presenting the document may comprise any graphical display means, such as a screen of a computer. Alternatively, where a hard copy of the document is required, the medium may comprise a sheet of paper or paper-like material. The selection means may include a suggesting means for suggesting an alternative search term instead of the user-entered first search term, preferably utilising an index. The suggesting means may be arranged to provide a user with a plurality of suggested alternative search terms for each first search term. The means for carrying out the first selection may use the first search term or any one of the suggested alternative search terms as the basis for the selection, depending on the requirements of the user.

A further aspect of the invention provides a system for providing information to a user obtained from a plurality of records stored on a database, each record containing a passage of information, wherein the system is arranged to enable the user to select characteristics of the passages, and the system is arranged to provide the information in the form of a document assembled from passages having the selected characteristics.

Each record may include a descriptor which indicates a characteristic of the information contained in the record, in accordance with any one of the embodiments described above.

The system may further comprise means for the user to choose a set of one of more of the descriptors. The system may also comprise a selection means for selecting any record concerning the predetermined topic which includes a descriptor matching a descriptor in the set chosen by the user. The predetermined topic may include, but is not limited to, the following examples:

keywords;

names;

subjects;

dates;

phrases; and

combinations of two or more of these.

A further aspect of the invention provides a computer-readable medium containing instructions for controlling a computer to assemble a document from a plurality of passages of information stored in a respective plurality of records on a database, each record including at least one descriptor which is indicative of a characteristic of information contained in the passage of the respective record, by carrying out the method described in the first aspect of the invention.

A further aspect of the invention provides a system for assembling a document from information stored in a plurality of records on a database, the system comprising:

a searching means for selecting and retrieving a set of records from the plurality of records using at least one predetermined selection criterion; and

an assembling means for assembling information in the retrieved records as a single document.

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

Embodiments of the invention will now be described, by way of example only, with reference to the accompanying drawings.

### BRIEF DESCRIPTION OF THE DRAWINGS

FIG. 1 shows a schematic drawing of a system in accordance with an embodiment of the present invention.

FIG. 2 shows an example of records selected as a result of a first selection carried out in accordance with an embodiment of the present invention.

FIG. 3 shows passages selected from the records in FIG. 2 for display to a lay reader.

FIG. 4 shows passages selected from the records in FIG. 2 for display to an intermediate level reader.

FIG. 5 shows passages selected from the records in FIG. 2 for display to an advanced level reader.

FIG. 6 illustrates a portion of an index linking various user-entered terms with a suggested alternative term.

FIG. 7 illustrates a display in which a suggested alternative term is provided in response to a user-entered term using the index in FIG. 6.

FIG. 8 illustrates another example of portion of an index in which a user-entered term is linked to two suggested alternative terms.

FIG. 9 illustrates a display showing suggested alternative terms provided in response to a user-entered term using the index in FIG. 8.

### DETAILED DESCRIPTION OF THE DRAWINGS

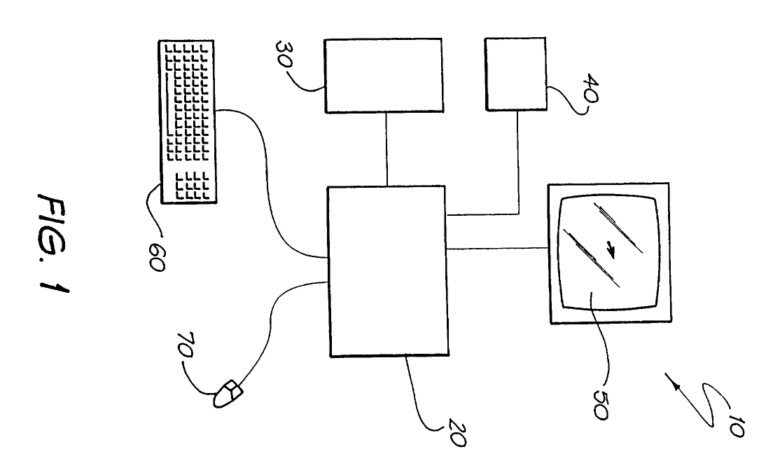

FIG. 1 is a schematic diagram illustrating a computer system 10 by which an embodiment of the present invention may be implemented. The computer system 10 includes a processor 20 for processing information coupled to a main memory 30, such as random access memory (RAM) or other dynamic storage device, for storing information and instructions to be executed by the processor. The main memory 30 may also be used for storing temporary variables or other intermediate information during execution of instructions to be executed by the processor. The computer system 10 further includes a read only memory (ROM) 40 or other static storage device for storing static information and instructions for the processor 20.

The computer system 10 is coupled to a display 50, such as a cathode ray tube, for displaying information to a computer user. An input device 60, including alphanumeric and other keys, is coupled to the processor for communicating information and command selections. Another type of user input device is a cursor controller 70, such as a mouse, a trackball, or cursor direction keys for communicating direction information and command selections to the processor and for controlling cursor movement on the display.

The term “computer readable medium” as used herein refers to any medium that participates in providing instructions to the processor for execution. Such a medium may take many forms including but not limited to, non-volatile media, volatile media and transmission media. Non-volatile media includes, for example, optical or magnetic storage disks. Volatile media includes dynamic memory, such as the main memory 30. Transmission media includes collaxial cables, copper wire and fibre optics. Transmission media can take the form of acoustic or light waves, such as those generated during radio wave and infra red data communications. Common forms of computer readable media include, for example, a floppy disk, a flexible disk, hard disk, magnetic tape, or any other magnetic medium. A CD ROM, any other optical medium, punch cards, paper tape, any other physical medium with patterns of holes, RAM, PROM, EPROM, FLASH-EPROM, any other memory chip or cartridge, a carrier wave, or any other medium which a computer can read. Various forms of computer readable medium may be involved in carrying out one or more sequences of one or more instructions to the processor for execution.

An embodiment of the present invention will now be described in which the computer system 10 is used to selectively display particular aspects of information stored in a database on the ROM 40.

In the present embodiment, the database stores text, but it will be understood that many other types of data, such as digitised images, may be stored on the database. The text in this embodiment is text of a legal encyclopaedia comprising case law, statutes and commentaries. The text is divided into modular passages of text such that a plurality of such passages can be assembled together to form a document. Each passage is saved as part of a data structure referred to as a record. The record can be searched and retrieved by the processor 20. Each record also includes at least one descriptor which classifies the passage as being suitable for presentation as introductory material, intermediate material, or advanced material. For example, a judge name, case name, or quote from a case is considered here to be advanced material. Intermediate material is considered to be either a quote from a statute or commentaries aimed at people with at least some legal experience, while introductory material is aimed at lay people without any legal experience.

Each record also includes at least one attribute definer which defines attributes of the record such as the presentation format, and information about where the record should be presented. For example, the attribute definer for a major heading defines that the heading appears at the top of a body of text and is presented in bold capital letters. In another example, the attribute definer for footnote material defines that the record is presented at the bottom of a body of text in a small plain font.

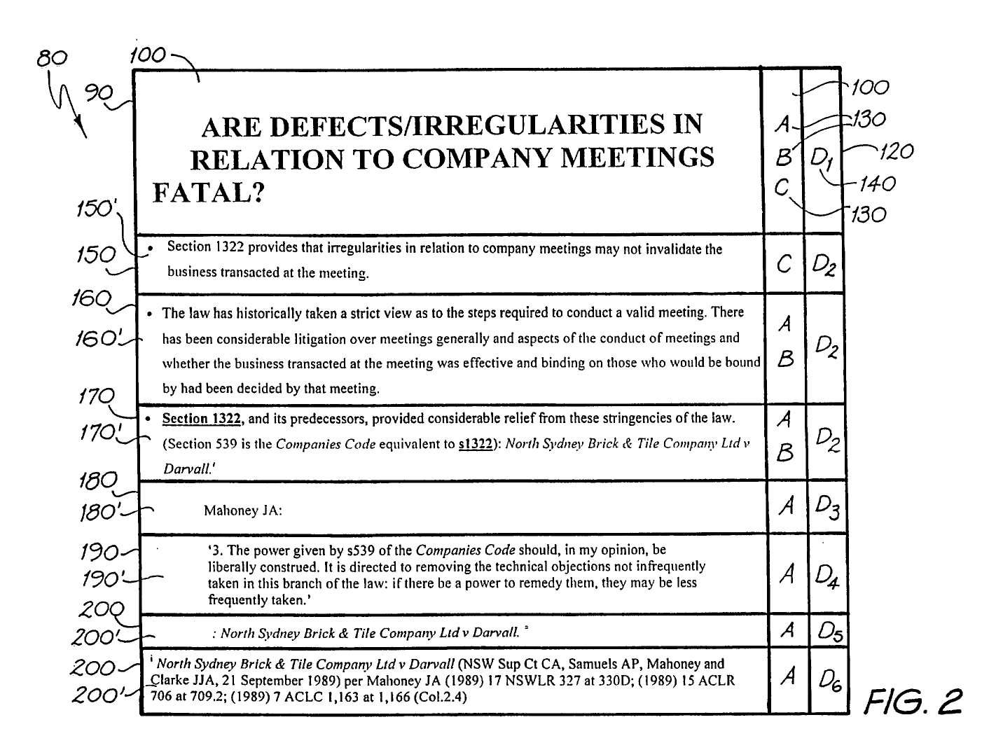

Presenting information to a user involves a two-step selection procedure. The first selection step involves searching through the database to find records which fall within predetermined selection criteria. The second step will be described further on. Each selection criterion used in the first selection step is specified by the user and may comprise searching through records on the database and selecting any record which contains a passage concerned with a particular search term, such as a subject, keyword, name, phrase, or date. FIG. 2 shows eight records 80 which were selected in an embodiment of the first selection step. These records are not displayed to the user.

The records 80 were selected in response to a selection criterion which comprised a search query for information about a particular point of law, using the keywords “COMPANY MEETINGS”. Each record 90 contains a passage 100 of text, one or more descriptors 110, and one or more attribute definers 120. The descriptors 110 are shown by the symbols A, B and C (130) representing advanced material, intermediate material and introductory material, respectively. The attribute definers 120 are shown with the symbols D₁, D₂, . . . D₅ (140), and are defined as follows:

| | |
|---|---|
| D₁ | heading text; |
| D₂ | body text; |
| D₃ | judge name; |
| D₄ | quote; |
| D₅ | case name; |
| D₆ | footnote text. |

The first record 90 contains a passage 100 which functions as a heading. Since this heading is required when presenting the introductory, intermediate and advanced level material, the record includes all three descriptors A, B and C. The passage 150′ contained in the second record 150 is introductory material and would not be presented to an intermediate or advanced level reader, so the only descriptor is C. The passages 160′, 170′ in the third and fourth records 160, 170 are relevant to intermediate and advanced level readers, and the descriptors consequently comprise A and B. The passages 180′-210′ in the fifth through to eighth records 180-210 comprise judge names, case quotes and case names. Such material is technical and relevant only to advanced level readers. The descriptor for each of these records therefore comprises A only.

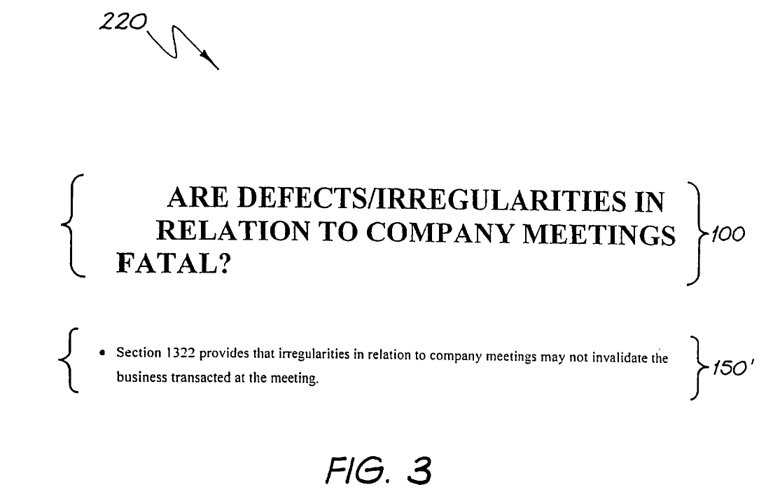

The second step of the selection procedure involves selecting records from the set of eight records 80 shown in FIG. 2. The selection takes place when a user chooses one of the descriptors, A, B, or C. FIG. 3 shows the information 220 presented to a user on the display means 50 as a result of selecting descriptor C, namely the descriptor for introductory material. The passages 100′, 150′ corresponding to the first and second records 90, 150 (shown in FIG. 2) are displayed in FIG. 3, since those are the only records including the descriptor C.

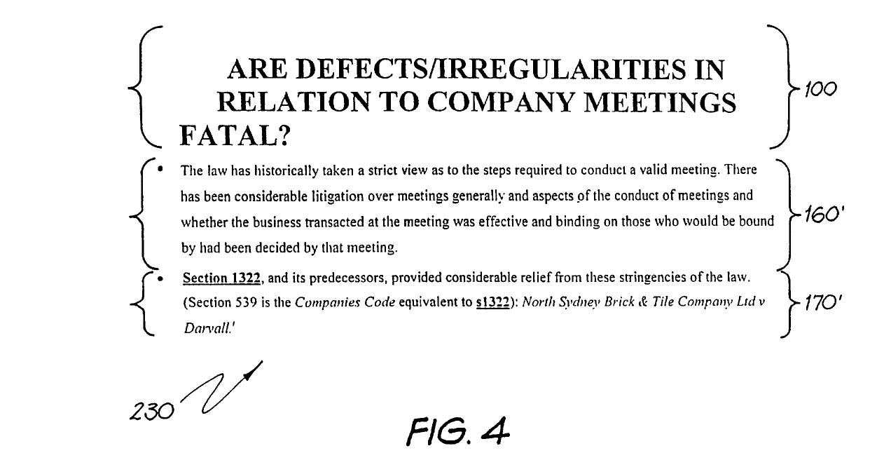

FIG. 4 shows the information 230 presented to a user who has selected descriptor B, namely, intermediate material. The passages 100′, 160′, 170′ corresponding to the first, third and fourth records 90, 160, 170 are presented to the user.

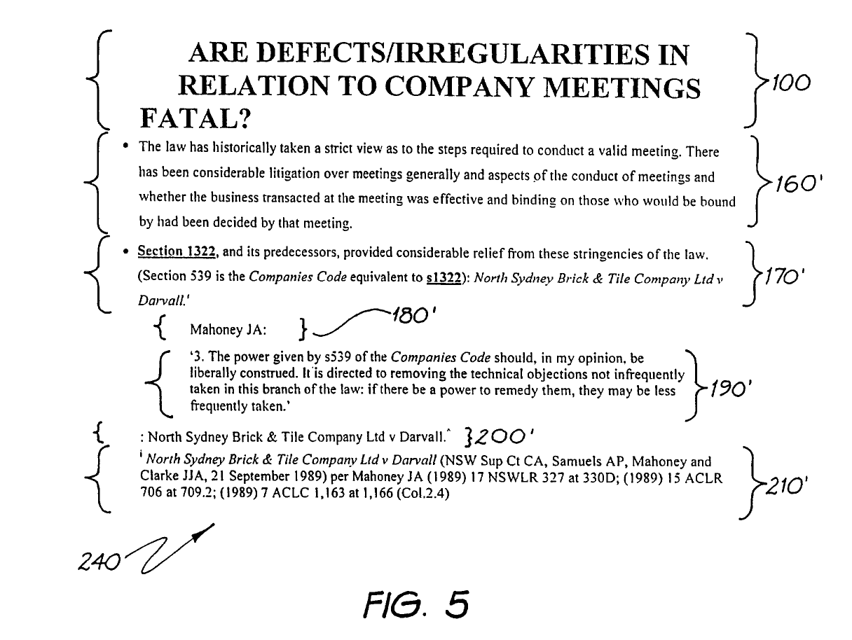

FIG. 5 shows the information 240 presented to a user who has selected descriptor A, namely, advanced material. The only passage which is not displayed is the passage 150′ corresponding to the second record 150, since this is the only record which does not include descriptor A.

In order to facilitate the selection process in the first selection step, an indexing system is provided to guide the user towards using the most effective search term for their needs. For example, the user may enter a phrase which is out of date, and the index may suggest an alternative phrase which is up-to-date and has the equivalent meanings. In another example, the user may enter a keyword which covers a large number of topics. Rather than providing a vast number of records which all relate to the keyword, the index provides a list of sub-topics or sub-options.

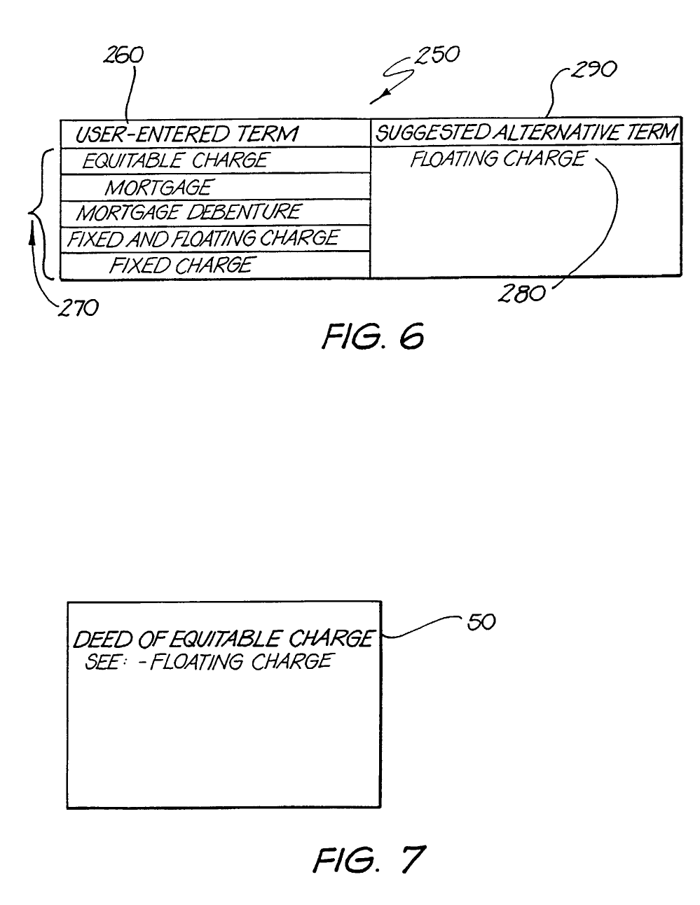

FIG. 6 shows a table 250 which schematically represents a portion of data in the index. The left-hand column 260 lists a number of terms 270 which might be entered by a user and which all generally mean the same thing. In this case, the index suggests one alternative term 280 in the right-hand column 290, namely “floating charge”.

FIG. 7 shows the display 50 as seen by a user when the expression “deed of equitable charge” is entered as a search term. The index has provided the suggested alternative term “floating charge” and the user is at liberty to use the suggested alternative term instead of the term which was initially entered.

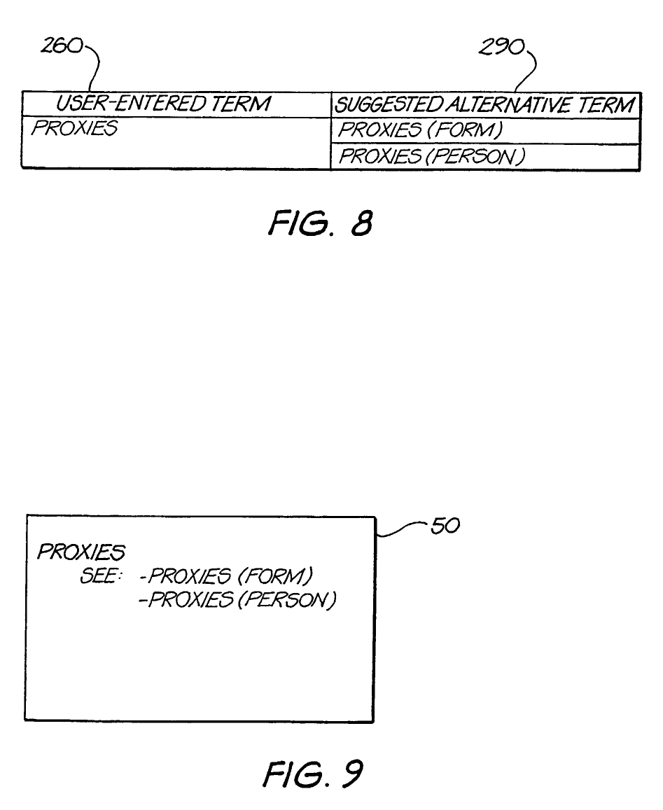

FIG. 8 shows a table schematically representing the data structure of another portion of the index. The left-hand column 260 lists the term “proxies” as a term which might be entered by a user, and the right-hand column 290 suggests two alternative terms. The word “proxies” can either mean a form used to authorise someone to represent a person at a meeting, or can be a person who is making the representation at the meeting. The index therefore lists both of these options to guide the user towards a narrower search, rather than listing records relevant to both meanings of the word. FIG. 9 shows the display 50 as seen by a user when entering the search term “proxies”.

Throughout the specification the term “record” is understood to mean any data structure which a database may use to catalogue and retrieve an item of information, and may include a pointer to a location in a computer memory.

Although the present invention has been largely described using an example of a legal database, it will be understood that the present invention may also be used with many other types of databases. For example, the present invention may be implemented with databases storing various types of literature in the form of text such as instruction manuals, handbooks, encyclopedias, directories, resource material, as well as non-textual material such as images, sounds, colours, or symbols.

It will be appreciated by a person skilled in the art that numerous variations and/or modifications may be made to the present invention as shown in the specific embodiments without departing from the spirit or scope of the invention as broadly described. The present embodiments are therefore to be considered in all respects to be illustrative and not restrictive.

The claims defining the invention are as follows:

1. A method of assembling a document from a plurality of passages of information stored in a respective plurality of records on a database, each record including at least one descriptor which is indicative of a characteristic of information contained in the passage of the respective record, comprising:
selecting a least two records from the plurality of records, the selected records comprising all records having a descriptor which matches a descriptor chosen by a user;
creating a document containing the passages of the selected records;
presenting the document such that the passages contained in it are directly viewable by a user.

2. A method in accordance with claim 1 wherein each passage is presented in the document in the form of one or more of the following:
a text character; a text word; a text phrase; a text paragraph; a symbol; a number; a data sequence; an image; and a drawing.

3. A method in accordance with either claim 1 or claim 2 wherein the information in each passage is presented in a predetermined arrangement comprising one or more of the following arrangements:
a heading; a sub-heading; a body of text; a footnote; and a hyperlink.

4. A method in accordance with any one of the proceeding claims wherein the passages contained in the document are presented sequentially in the form of an article which can be read by a user.

5. A method in accordance with any one of the proceeding claims wherein each descriptor is indicative of one of the following information characteristics:
type of information contained in a passage;
level of complexity of information contained in a passage;
quantity of information contained in a passage;
quality of information contained in a passage;
source of information contained in a passage;
language of information contained in a passage.

6. A method in accordance with claim 1, wherein the method further comprises selecting all records which, in addition to having the descriptor which matches a user-chosen descriptor, also satisfy a second selection criterion.

7. A method in accordance with claim 6 wherein the second selection criterion is determined by a user.

8. A method in accordance with either claim 6 or claim 7 wherein the second selection criterion requires each selected passage to contain a search term supplied by a user.

9. A method in accordance with any one of claims 6-8 wherein the selection of records based on the second selection criterion comprises:
receiving a user-entered first search term;
providing the user with a suggested alternative search term related to both the first search term and a least one of the passages in the plurality of records on the database.

10. A method in accordance with any one of the proceeding claims wherein at least one of the descriptors is linked to a least another one of the other descriptors such that when a user chooses any one of the linked descriptors, all of the linked descriptors are treated as being chosen by the user.

11. A method in accordance with any one of the preceeding claims wherein each record includes at least one attribute definer for defining a function or format of the passage contained in the record.

12. A system for assembling a document from a plurality of passages of information stored in a respective plurality of records on a database, each record including at least one descriptor which is indicative to a characteristic of information contained in the passage of the respective record, the system comprising:
a selection means for selecting at least two records from the plurality of records such that each of the at least two records satisfies both of the following conditions: each selected record includes a descriptor which matches a descriptor chosen by a user; each selected record satisfies a second selection criterion;
a document assembly means for assembling the passages of the selected records into a document;
a medium for presenting the document such that the passages contained in it are directly viewable by the user.

13. A system in accordance with claim 12 wherein the selection means comprises a digital searching tool operating on a computing device.

14. A system in accordance with either claim 12 or 13 wherein the document assembly means comprises a digital computing device.

15. A system in accordance with any one of claims 12-14 wherein the medium for presenting the document comprises a graphical display means.

16. A system in accordance with any one of claims 12-15 further comprising a user interface for enabling a user to input at least one selected descriptor and the second selection criterion.

17. A system in accordance with any one of claims 12-15 wherein the second selection criterion comprises selecting passages which contain a user-entered search term.

18. A system in accordance with claim 17 wherein the selection means further comprises a suggesting means for suggesting to the user a new search term which is an alternative to the user-entered first search term.

19. A system in accordance with claim 18 wherein the suggesting means includes an index which links a user-entered search term with an alternative search term.

20. A system for providing information to a user obtained from a plurality of records stored on a database, each record containing a passage of information, wherein the system is arranged to enable the user to select characteristics of the passages, and the system is arranged to provide the information in the form of a document assembled from passages having the selected characteristics.

21. A computer-readable medium containing instructions for controlling a computer to assemble a document from a plurality of passages of information stored in a respective plurality of records on a database, each record including at least one descriptor which is indicative of a characteristic of information contained in the passage of the respective record, by carrying out the method defined in any one of claims 1-11.

22. A system for assembling a document from information stored in a plurality of records on a database, the system comprising:
a searching means for selecting and retrieving a set of records from the plurality of records using at least one predetermined selection criterion; and
an assembling means for assembling information in the retrieved records as a single document.
